(19) United States
(12) Patent Application Publication
(10) Pub. No.: US 2026/0073744 A1
(43) Pub. Date: Mar. 12, 2026

(54) IN-VEHICLE LIVING SUBJECT MONITORING METHOD AND IN-VEHICLE LIVING SUBJECT MONITORING SYSTEM

(71) Applicant: WNC Corporation, Hsinchu (TW)

(72) Inventors: Chia-Chih CHANG, Hsinchu (TW); Shu-Yi WU, Hsinchu (TW)

(21) Appl. No.: 19/319,832

(22) Filed: Sep. 5, 2025

(30) Foreign Application Priority Data
Sep. 9, 2024 (TW) 113134096

(51) Int. Cl. G07C 5/08; B60Q 9/00

(52) U.S. Cl. CPC G07C 5/0808; B60Q 9/00

(57) ABSTRACT

An in-vehicle living subject monitoring method and system are provided. The in-vehicle living subject monitoring method is used to monitor a space inside a vehicle and includes detecting the space with a detector to obtain a plurality of point cloud information; with a processor, receiving the point cloud information from the detector, calculating the point cloud information to obtain a plurality of signal-to-noise ratios corresponding to the point cloud information, and calculating the signal-to-noise ratios to obtain an average value and a standard deviation of the signal-to-noise ratios; and performing a judging step with the processor. The judging step includes judging whether a living subject is present in the space according to the average value and the standard deviation to generate a state judgment result, and outputting a state parameter corresponding to a state of the space according to the state judgment result.

### RELATED APPLICATIONS

This application claims priority to Taiwan Application Serial Number No. 113134096, filed Sep. 9, 2024, which is herein incorporated by reference.

### BACKGROUND

### Technical Field

The present disclosure relates to a method and system for monitoring living subjects, and more particularly to an in-vehicle living subject monitoring method and an in-vehicle living subject monitoring system.

### Description of Related Art

In the automotive field, Child Presence Detection (CPD) has gradually gained attention to enhance safety. European regulations regarding CPD include two important descriptions: one is that when a child is left alone in the car without the ability to escape, the system must issue a warning within a specified time; the other is that when the warning has been issued and an adult comes to rescue or stay in the car, the system will continue to monitor and cancel the warning within a specified time. In the conventional technology, the practical application of CPD is not yet mature and its' effect is poor, and so there is a need for an effective and timely method and system for monitoring living subjects in the vehicle to determine whether a child is alone in the vehicle and issue a warning.

### SUMMARY

According to one aspect of the present disclosure, an in-vehicle living subject monitoring method is provided for monitoring a space inside a vehicle. The method includes detecting the space inside the vehicle with a detector to obtain a plurality of point cloud information; with a processor, receiving the point cloud information from the detector, calculating the point cloud information to obtain a plurality of signal-to-noise ratios corresponding to the point cloud information, and calculating the signal-to-noise ratios to obtain an average value and a standard deviation of the signal-to-noise ratios; and performing a judging step with the processor. The judging step includes judging whether a living subject is present in the space inside the vehicle according to the average value and the standard deviation to generate a state judgment result, and outputting a state parameter corresponding to the state of the space inside the vehicle according to the state judgment result.

According to another aspect of the present disclosure, an in-vehicle living subject monitoring method is provided for monitoring a space inside a vehicle. The method includes detecting the space inside the vehicle with a detector to obtain a plurality of point cloud information; with a processor, receiving the point cloud information from the detector, calculating the point cloud information to obtain a plurality of signal-to-noise ratios corresponding to the point cloud information, and calculating the signal-to-noise ratios to obtain one of an average value and a standard deviation of the signal-to-noise ratios; and performing a judging step with the processor. The judging step includes judging whether a living subject is present in the space inside the vehicle according to the one of the average value and the standard deviation of the signal-to-noise ratios and a number of point clouds in an upper space the space inside the vehicle to generate a state judgment result, and outputting a state parameter corresponding to the state of the space inside the vehicle according to the state judgment result.

According to yet another aspect of the present disclosure, an in-vehicle living subject monitoring system is provided for monitoring a space inside a vehicle and includes a detector and a processor. The detector is used to detect the space inside the vehicle to obtain a plurality of point cloud information. The processor is connected to the detector and receives the point cloud information. The processor calculates the point cloud information to obtain a plurality of signal-to-noise ratios corresponding to the point cloud information, calculates the signal-to-noise ratios to obtain an average value and a standard deviation of the signal-to-noise ratios, and performs a judging operation. The judging operation includes judging whether a living subject is present in the space inside the vehicle according to the average value and the standard deviation to generate a state judgment result, and outputting a state parameter corresponding to the state of the space inside the vehicle according to the state judgment result.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of an in-vehicle living subject monitoring system according to a first embodiment of the present disclosure.

FIG. 2 is a flowchart of an in-vehicle living subject monitoring method according to a second embodiment of the present disclosure.

FIG. 3 is a flowchart of the in-vehicle living subject monitoring method according to a third embodiment of the present disclosure.

FIG. 4A is a flowchart of a first score adjustment procedure of FIG. 3.

FIG. 4B is a flowchart of valid detection of FIG. 4A.

FIG. 4C is a flowchart of invalid detection of FIG. 4A.

FIG. 5A is a flowchart of a second score adjustment procedure of FIG. 3.

FIG. 5B is a flowchart of valid detection of FIG. 5A.

FIG. 5C is a flowchart of a first score adjustment mechanism for invalid detection of FIG. 5A.

FIG. 5D is a flowchart of a second score adjustment mechanism for invalid detection of FIG. 5A.

FIG. 6 is a flowchart of the in-vehicle living subject monitoring method according to a fourth embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

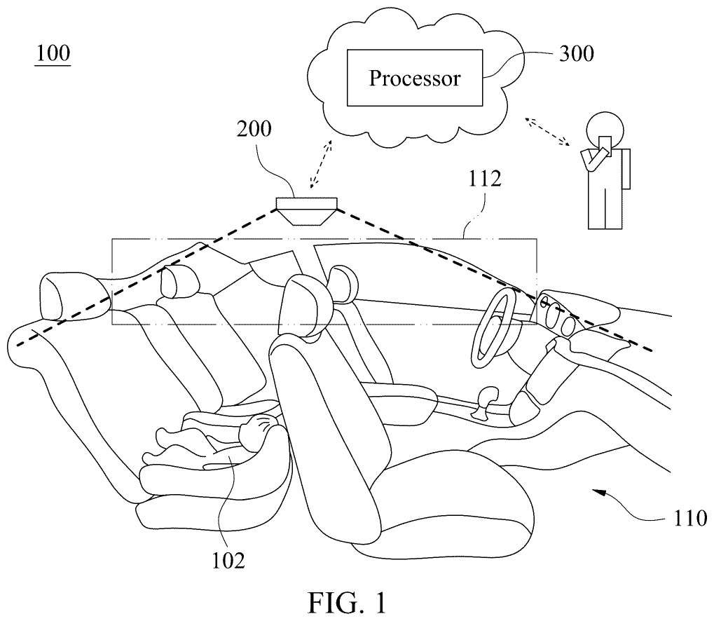

FIG. 1 is a schematic diagram of an in-vehicle living subject monitoring system 100 according to a first embodiment of the present disclosure. Referring to FIG. 1, the in-vehicle living subject monitoring system 100 is used to monitor a space 110 inside a vehicle and includes a detector 200 and a processor 300. The detector 200 is used to detect the space 110 inside the vehicle to obtain a plurality of point cloud information. The processor 300 is connected to the detector 200 and receives the point cloud information. The processor 300 calculates the point cloud information to obtain a plurality of signal-to-noise ratios corresponding to the point cloud information, and calculates the signal-to-noise ratios to obtain an average value and a standard deviation, and performs a judging operation. The judging operation includes judging whether there is a living subject (living being) 102 in the space 110 inside the vehicle (i.e., judging whether the living subject 102 is present in the space 110 inside the vehicle) according to the average value and the standard deviation to generate a state judgment result, and outputting a state parameter corresponding to the state of the space 110 inside the vehicle according to the state judgment result.

In one embodiment, the detector 200 can be a radar (such as Frequency Modulated Continuous Wave (FMCW) radar); the processor 300 can be a cloud processor, Digital Signal Processor (DSP), Micro Processing Unit (MPU), Central Processing Unit (CPU) or other electronic processors, and the processor 300 can transmit the state parameter corresponding to the state of the space 110 inside the vehicle to a user's mobile device (such as a mobile phone); the living subject 102 can be a child; the space 110 inside the vehicle includes an upper space 112, and each point cloud information includes coordinate values (x, y, z). The present disclosure is not limited to the above.

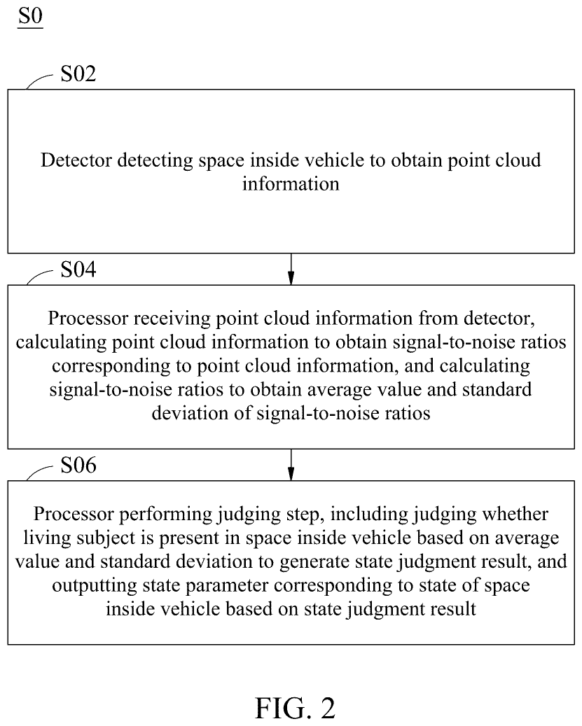

FIG. 2 is a flowchart of an in-vehicle living subject monitoring method S0 according to a second embodiment of the present disclosure. Referring to FIGS. 1 and 2, the in-vehicle living subject monitoring method S0 is used to monitor the space 110 inside the vehicle and is applied to the in-vehicle living subject monitoring system 100, including steps S02, S04, S06. Step S02 includes detecting the space 110 inside the vehicle with the detector 200 to obtain a plurality of point cloud information. Step S04 includes receiving the point cloud information from the detector 200 with the processor 300, and calculating the point cloud information to obtain a plurality of signal-to-noise ratios corresponding to the point cloud information, and calculating the signal-to-noise ratios to obtain an average value and a standard deviation. Step S06 includes performing a judging step with the processor 300. The judging step includes judging whether there is a living subject 102 in the space 110 inside the vehicle (i.e., judging whether the living subject 102 is present in the space 110 inside the vehicle) according to the average value and the standard deviation to generate a state judgment result, and outputting a state parameter corresponding to the state of the space 110 inside the vehicle according to the state judgment result.

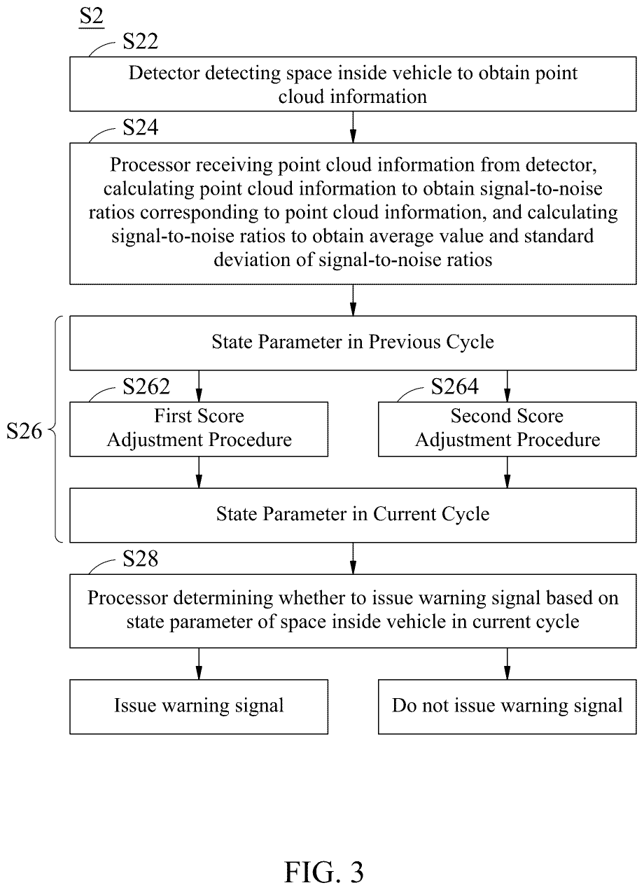

FIG. 3 is a flowchart of the in-vehicle living subject monitoring method S2 according to the third embodiment of the present disclosure. Referring to FIGS. 1, 2, and 3, the in-vehicle living subject monitoring method S2 is used to monitor the space 110 inside the vehicle and is applied to the in-vehicle living subject monitoring system 100. During the monitoring process, from the start (when a condition triggering the start of monitoring is met, such as engine shutdown) to the end (when a condition triggering the end of monitoring is met, such as engine startup), the detector 200 of the in-vehicle living subject monitoring system 100 will continuously receive signals and will continuously use the in-vehicle living subject monitoring method S2 to monitor the space 110 inside the vehicle. Each time the detector 200 receives a signal, the in-vehicle living subject monitoring system 100 will execute the process of the in-vehicle living subject monitoring method S2 once to make a CPD judgment. In addition, the monitoring process can be divided into multiple cycles from start to end, for example: the (i−1)th cycle (previous cycle), the ith cycle (current cycle), etc., where i is a positive integer greater than or equal to 2, and each cycle will execute the process of the in-vehicle living subject monitoring method S2 once. In other words, as long as the monitoring has not ended, regardless of whether a warning signal is issued, the in-vehicle living subject monitoring method S2 will be periodically executed to continuously monitor the space 110 inside the vehicle until the condition triggering the end of monitoring is met. The in-vehicle living subject monitoring method S2 includes steps S22, S24, S26, S28. Steps S22, S24 are the same as steps S02, S04 in FIG. 2, and will not be repeated herein.

Step S26 includes performing a judging step with the processor 300. The judging step includes judging whether there is a living subject 102 in the space 110 inside the vehicle according to the average value and the standard deviation to generate a state judgment result, and outputting a state parameter corresponding to the state of the space 110 inside the vehicle according to the state judgment result. Specifically, the judging step further includes determining whether to execute a first score adjustment procedure S262 or a second score adjustment procedure S264 in the current cycle based on the state parameter of the previous cycle to generate a decision result; and performing a computation on a score value based on the decision result and determining whether to adjust the state parameter based on the computed score value (i.e., the score value computed by the computation). The state parameter is one of a first state parameter and a second state parameter, where the first state parameter represents that there is a living subject 102 in the space 110 inside the vehicle, and the second state parameter represents that there is no living subject 102 in the space 110 inside the vehicle. The first score adjustment procedure S262 and the second score adjustment procedure S264 are different from each other, where the first score adjustment procedure S262 corresponds to “the state parameter of the previous cycle is the first state parameter”, and the second score adjustment procedure S264 corresponds to “the state parameter of the previous cycle is the second state parameter”.

Step S28 includes determining whether to issue a warning signal based on the state parameter of the space 110 inside the vehicle in the current cycle with the processor 300. When the state parameter of the space 110 inside the vehicle in the current cycle is the first state parameter, the processor 300 issues a warning signal. When the state parameter of the space 110 inside the vehicle in the current cycle is the second state parameter, the processor 300 does not issue a warning signal.

Accordingly, the in-vehicle living subject monitoring system 100 and the in-vehicle living body monitoring methods S0 and S2 of the present disclosure obtain a state parameter corresponding to the vehicle interior space 110 (i.e., the space 110 inside the vehicle) by determining based on the average value and standard deviation and by calculating a score value, thereby effectively determining whether a child is present alone in the vehicle interior space 110 and whether to issue a warning.

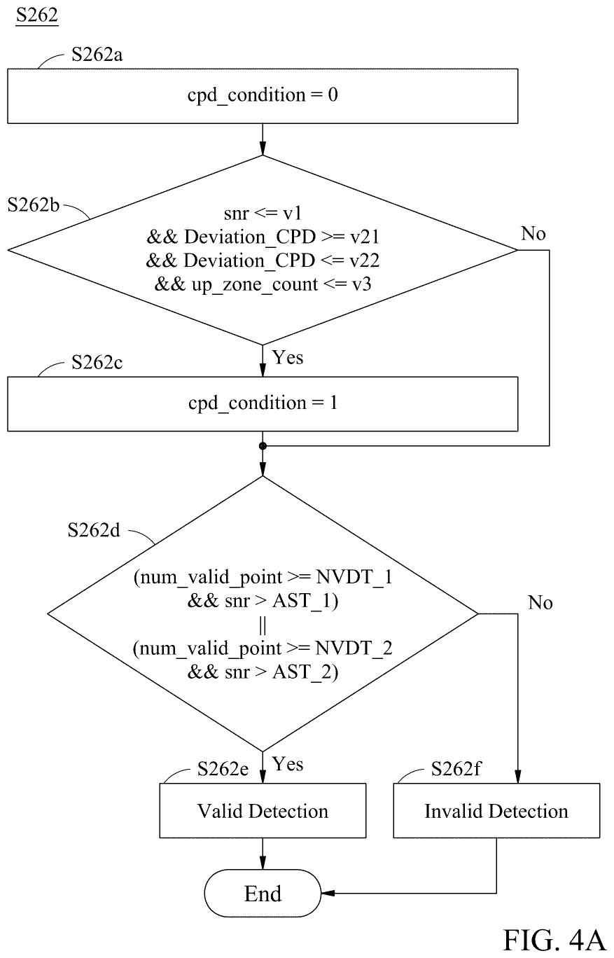

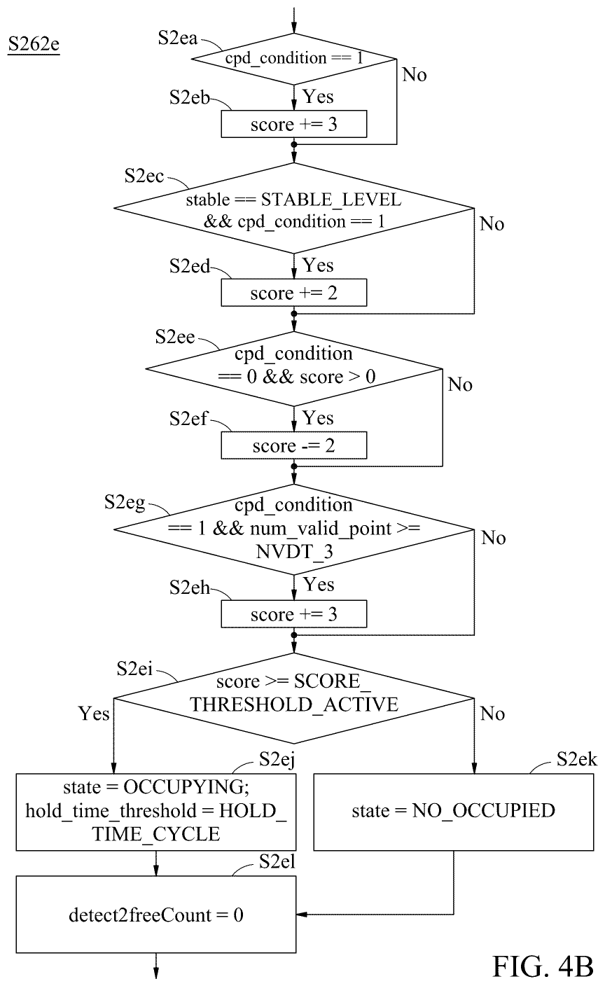

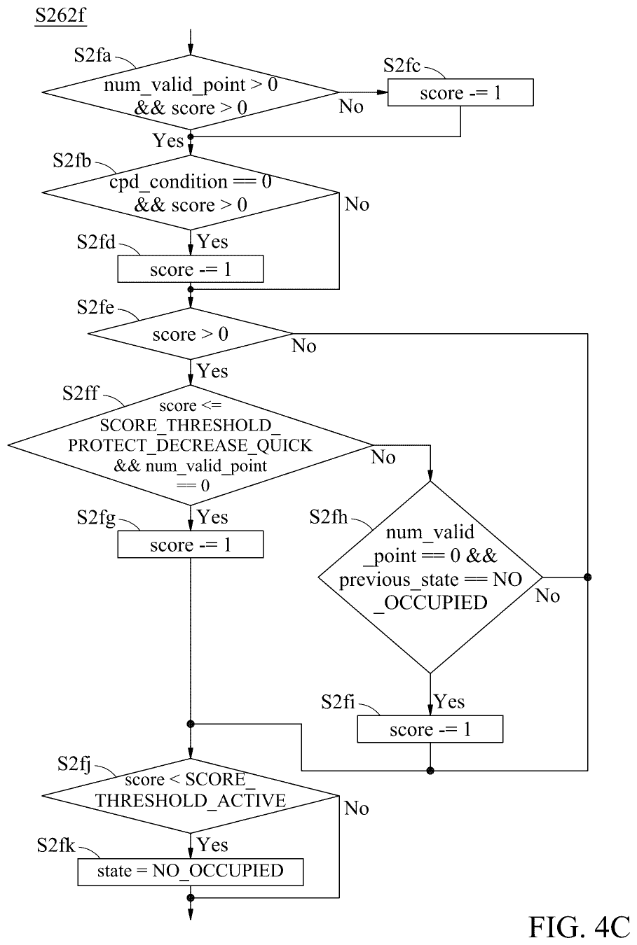

FIG. 4A is a flowchart of the first score adjustment procedure S262 of FIG. 3. Referring to FIGS. 3 and 4A, the first score adjustment procedure S262 includes steps S262a, S262b, S262c, S262d, S262e, S262f. Step S262a includes setting a child sensing state parameter (cpd_condition) to 0. The child sensing state parameter equal to 0 represents that there is no living subject 102 in the space 110 inside the vehicle. In other words, the living subject 102 is not present in the space 110.

Step S262b includes comparing whether the average value (snr) of the signal-to-noise ratios is less than or equal to a preset average value (v1) to generate a first comparison result, comparing whether the standard deviation (Deviation_CPD) of the signal-to-noise ratios is between two preset standard deviations (v21, v22) to generate a second comparison result, and determining whether the number of point clouds in the upper space 112 of the space 110 inside the vehicle (up_zone_count) is less than or equal to a preset upper space point number value (v3) to generate a point number determination result, and judging whether there is a living subject 102 in the space 110 inside the vehicle based on the first comparison result, the second comparison result, and the point number determination result. When the first comparison result is yes, the second comparison result is yes, and the point number determination result is yes, the processor 300 executes step S262c (i.e., the processor 300 judges that there is a living subject 102 in the space 110 inside the vehicle); otherwise, the processor 300 executes step S262d.

The preset average value, the two preset standard deviations, and the preset upper space point number value correspond to a plurality of characteristic values of the living subject 102 detected by the detector 200. In one embodiment, when the living subject 102 is a child, the preset average value (v1) can be 14 dB (25 watts), the two preset standard deviations (v21, v22) can be 2.2 and 8.2 respectively (considered as a range, when the living subject 102 is a child, the corresponding standard deviation will be between v21 and v22, i.e., this range corresponds to the characteristic values of the living subject 102 detected by the detector 200), and the preset upper space point number value (v3) can be 5, but the present disclosure is not limited thereto. In other embodiments, step S262b can include judging whether there is a living subject 102 in the space 110 inside the vehicle based on only any two of the first comparison result, the second comparison result, and the point number determination result (e.g., judging whether there is a living subject 102 in the space 110 inside the vehicle based on only the first comparison result and the second comparison result. When the first comparison result is yes and the second comparison result is yes, the processor 300 judges that there is a living subject 102 in the space 110 inside the vehicle; otherwise, the processor 300 judges that there is no living subject 102 in the space 110 inside the vehicle).

Step S262c includes setting the child sensing state parameter to 1. The child sensing state parameter equal to 1 represents that there is a living subject 102 in the space 110 inside the vehicle. In other words, the living subject 102 is present in the space 110.

Step S262d includes judging whether the point cloud information is a valid detection (effective detection) based on a first detection judgment condition to generate a first detection judgment result, where valid detection includes the presence of the living subject 102 in the space 110 inside the vehicle. The first detection judgment condition includes the number (num_valid_point) of the point cloud information being greater than or equal to a first preset quantity threshold value; and the average value of the signal-to-noise ratios being greater than a first preset average threshold value. The first preset quantity threshold value can be one of a quantity threshold value (NVDT_1, where NVDT is the abbreviation of “NUM VALID DETECTION THRESHOLD”) and another quantity threshold value (NVDT_2); the first preset average threshold value can be one of an average threshold value (AST_1, where AST is the abbreviation of “AVG SNR THRESHOLD”) and another average threshold value (AST_2). In this embodiment, the first detection judgment condition includes a first judgment condition or a second judgment condition. The first judgment condition includes the number of the point cloud information being greater than or equal to the quantity threshold value (NVDT_1); and the average value of the signal-to-noise ratios being greater than the average threshold value (AST_1). The second judgment condition includes the number of the point cloud information being greater than or equal to another quantity threshold value (NVDT_2); and the average value of the signal-to-noise ratios being greater than another average threshold value (AST_2). In addition, when the first detection judgment result is yes, the processor 300 executes step S262e; when the first detection judgment result is no, the processor 300 executes step S262f.

Step S262e includes performing score calculation corresponding to valid detection. In step S262e, the processor 300 performs at least one addition computation on the score value based on a first parameter set to generate a first adjusted score value, and then determines whether to adjust the state parameter based on the first adjusted score value. The first parameter set includes a child sensing state parameter, the consistency of the movement of the living subject 102, the score value, and the number of the point cloud information. The consistency of the movement of the living subject 102 can be represented by a numerical value, where a higher numerical value indicates more consistent movement of the living subject 102. The size of the score value corresponds to the likelihood that the living subject 102 is a child.

Step S262f includes performing score calculation corresponding to non-valid detection (invalid detection, non-effective detection). In step S262f, the processor 300 performs at least one subtraction computation on the score value based on another first parameter set to generate another first adjusted score value, and then determines whether to adjust the state parameter based on the another first adjusted score value. The another first parameter set includes a child sensing state parameter, the score value, and the number of the point cloud information.

FIG. 4B is a flowchart of valid detection (step S262e) of FIG. 4A. Referring to FIGS. 3, 4A, and 4B, in this embodiment, step S262e includes steps S2ea, S2eb, S2ec, S2ed, S2ee, S2ef, S2eg, S2eh, S2ei, S2ej, S2ek, S2el. Step S2ea includes confirming whether the child sensing state parameter is equal to 1 to generate a first confirmation result. When the first confirmation result is yes, the processor 300 executes step S2eb; when the first confirmation result is no, the processor 300 executes step S2ec. Step S2eb includes performing an addition computation (adding 3) on the score value. Step S2ec includes confirming whether the consistency (stability) of the movement of the living subject 102 is greater than a preset stable value (STABLE_LEVEL) and whether the child sensing state parameter is equal to 1 to generate a second confirmation result. When the second confirmation result is yes, the processor 300 executes step S2ed; otherwise, the processor 300 executes step S2ee. Step S2ed includes performing an addition computation (adding 2) on the score value. Step S2ee includes confirming whether the child sensing state parameter is equal to 0 and whether the score value is greater than 0 to generate a third confirmation result. When the third confirmation result is yes, the processor 300 executes step S2ef; otherwise, the processor 300 executes step S2eg. Step S2ef includes performing a subtraction computation (subtracting 2) on the score value.

Step S2eg includes confirming whether the child sensing state parameter is equal to 1 and whether the number of the point cloud information is greater than or equal to a quantity threshold value (NVDT_3) to generate a fourth confirmation result. When the fourth confirmation result is yes, the processor 300 executes step S2eh; otherwise, the processor 300 executes step S2ei. Step S2eh includes performing an addition computation (adding 3) on the score value. Step S2ei includes confirming whether the score value is greater than or equal to a preset alarm activation threshold value (SCORE_THRESHOLD_ACTIVE) to generate a fifth confirmation result. When the fifth confirmation result is yes, the processor 300 executes step S2ej; otherwise, the processor 300 executes step S2ek. Step S2ej includes setting the state parameter to the first state parameter (OCCUPYING) and setting a hold alarm time threshold value to a preset alarm period (HOLD_TIME_CYCLE). The hold alarm time threshold value represents the threshold value of the duration of the warning signal. Step S2ek includes setting the state parameter to the second state parameter (NO_OCCUPIED). Step S2el includes setting a cycle count parameter (detect2freeCount) to 0. The cycle count parameter represents the cycle period of issuing the warning signal. Finally, the score value obtained after executing step S2ea is the first adjusted score value, and the higher the score value, the higher the likelihood that the living subject 102 is alone in the space 110 inside the vehicle.

FIG. 4C is a flowchart of invalid detection (step S262f) of FIG. 4A. Referring to FIGS. 3, 4A, 4B, and 4C, in this embodiment, step S262f includes steps S2fa, S2fb, S2fc, S2fd, S2fe, S2ff, S2fg, S2fh, S2fi, S2fj, S2fk. Step S2fa includes confirming whether the number of the point cloud information is greater than 0 and whether the score value is greater than 0 to generate a first confirmation result. When the first confirmation result is yes, the processor 300 executes step S2fb; when the first confirmation result is no, the processor 300 executes step S2fc. Step S2fc includes performing a subtraction computation (subtracting 1) on the score value. Step S2fb includes confirming whether the child sensing state parameter is equal to 0 and whether the score value is greater than 0 to generate a second confirmation result. When the second confirmation result is yes, the processor 300 executes step S2fd; otherwise, the processor 300 executes step S2fe. Step S2fd includes performing a subtraction computation (subtracting 1) on the score value. Step S2fe includes confirming whether the score value is greater than 0 to generate a third confirmation result. When the third confirmation result is yes, the processor 300 executes step S2ff; otherwise, the processor 300 executes step S2fj.

Step S2ff includes confirming whether the score value is less than or equal to a preset acceleration reduction threshold value (SCORE_THRESHOLD_PROTECT_DECREASE_QUICK) and whether the number of the point cloud information is equal to 0 to generate a fourth confirmation result. When the fourth confirmation result is yes, the processor 300 executes step S2fg; otherwise, the processor 300 executes step S2fh. Step S2fg includes performing a subtraction computation (subtracting 1) on the score value. Step S2fh includes confirming whether the number of point cloud information is equal to 0 and whether the previous state parameter (previous_state) is the second state parameter to generate a fifth confirmation result. When the fifth confirmation result is yes, the processor 300 executes step S2fi; otherwise, the processor 300 executes step S2fj. Step S2fi includes performing a subtraction computation (subtracting 1) on the score value. Step S2fj includes confirming whether the score value is less than the preset alarm activation threshold value (SCORE_THRESHOLD_ACTIVE) to generate a sixth confirmation result. When the sixth confirmation result is yes, the processor 300 executes step S2fk; otherwise, the processor 300 ends step S262f. Step S2fk includes setting the state parameter to the second state parameter.

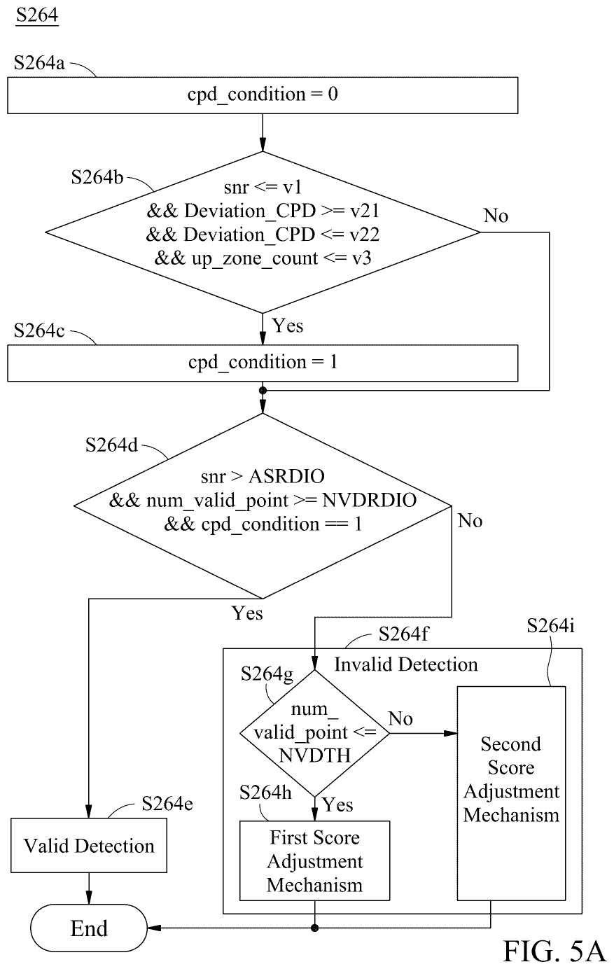

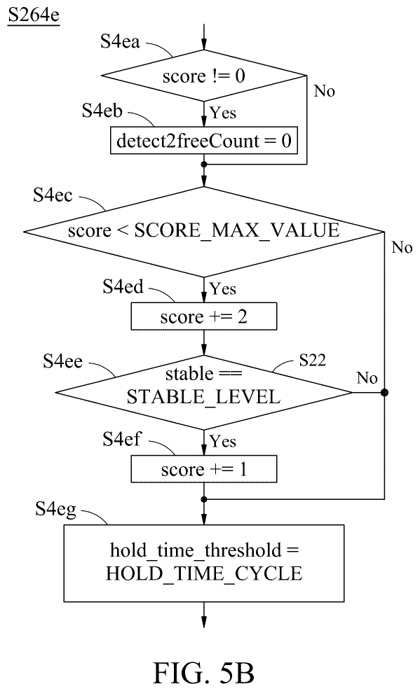

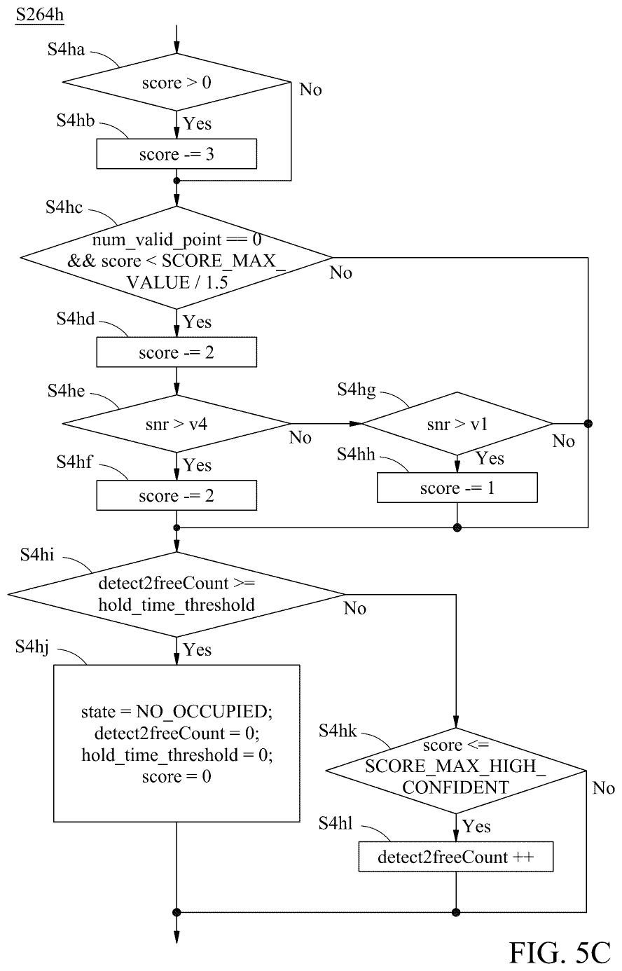

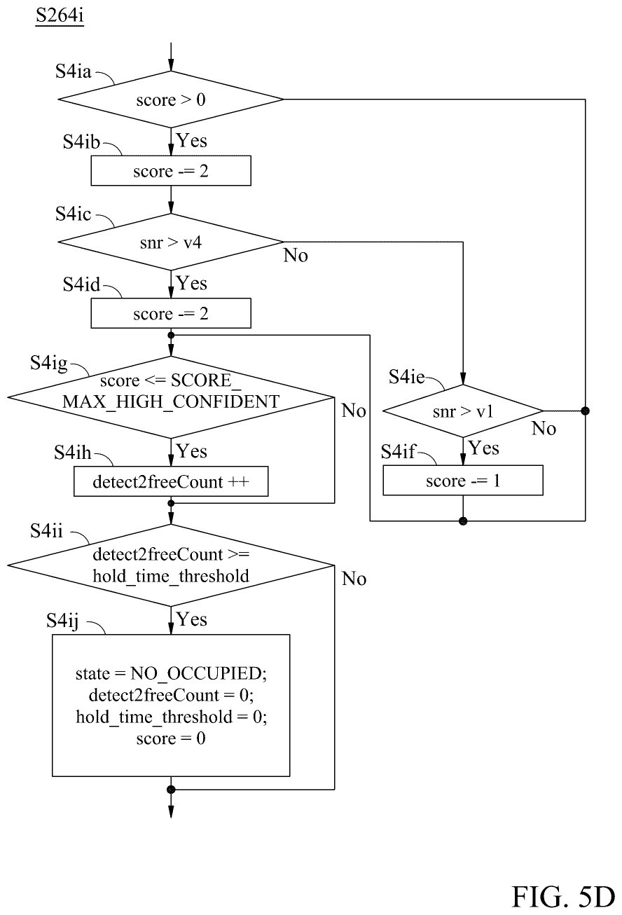

FIG. 5A is a flowchart of the second score adjustment procedure S264 of FIG. 3. Referring to FIGS. 3, 4A, 4B, 4C, and 5A, the second score adjustment procedure S264 includes steps S264a, S264b, S264c, S264d, S264e, S264f. Steps S264a, S264b, S264c are the same as steps S262a, S262b, S262c of FIG. 4A, and will not be repeated herein.

Step S264d includes judging whether the point cloud information is a valid detection based on a second detection judgment condition to generate a second detection judgment result, where valid detection includes the presence of a living subject 102 in the space 110 inside the vehicle. The second detection judgment condition includes the average value of the signal-to-noise ratios being greater than a second preset average threshold value (ASRDIO, which is the abbreviation of “AVG SNR REMAIN DETECTION IN OCCUPANCY”); the number of the point cloud information being greater than or equal to a second preset quantity threshold value (NVDRDIO, which is the abbreviation of “NUM VALID DETECTION REMAIN DETECTION IN OCCUPANCY”); and the child sensing state parameter being equal to 1, where the child sensing state parameter equal to 1 represents that there is a living subject 102 in the space 110 inside the vehicle. When the second detection judgment result is yes, the processor 300 executes step S264e; on the contrary, when the second detection judgment result is no, the processor 300 executes step S264f.

Step S264e includes performing score calculation corresponding to valid detection. In step S264e, the processor 300 performs at least one addition computation on the score value based on a second parameter set to generate a second adjusted score value, and then determines whether to adjust the state parameter based on the second adjusted score value. The second parameter set includes the score value and the consistency of the movement of the living subject 102.

Step S264f includes performing score calculation corresponding to invalid detection. In step S264f, the processor 300 performs at least one subtraction computation on the score value based on another second parameter set to generate another second adjusted score value, and then determines whether to adjust the state parameter based on the another second adjusted score value. The another second parameter set includes the number of the point cloud information, the score value, the average value of the signal-to-noise ratios, and a cycle count parameter.

FIG. 5B is a flowchart of valid detection (step S264e) of FIG. 5A. Referring to FIGS. 3, 5A, and 5B, in this embodiment, step S264e includes steps S4ea, S4eb, S4ec, S4ed, S4ee, S4ef, S4eg. Step S4ea includes confirming whether the score value is not equal to 0 to generate a first confirmation result. When the first confirmation result is yes, the processor 300 executes step S4eb; when the first confirmation result is no, the processor 300 executes step S4ec. Step S4eb includes setting the cycle count parameter to 0. Step S4ec includes confirming whether the score value is less than a maximum score value (SCORE_MAX_VALUE) to generate a second confirmation result. When the second confirmation result is yes, the processor 300 executes step S4ed; otherwise, the processor 300 executes step S4ee. Step S4ed includes performing addition computation (adding 2) on the score value. Step S4ee includes confirming whether the consistency of movement of the living subject 102 corresponds to the preset stable value to generate a third confirmation result. When the third confirmation result is yes, the processor 300 performs step S4ef; otherwise, the processor performs step S4eg. Step s4ef includes performing addition computation (adding 1) on the score value. Step S4eg includes setting the hold alarm time threshold value to the preset alarm period.

FIG. 5C is a flowchart of a first score adjustment mechanism (step S264h) for invalid detection (step S264f) in FIG. 5A; and FIG. 5D is a flowchart of a second score adjustment mechanism (step S264i) for invalid detection (step S264f) in FIG. 5A. Referring to FIGS. 3, 5A, 5B, 5C, and 5D, step S264f includes steps S264g, S264h, S264i. In FIG. 5A, step S264g includes confirming whether the number of point cloud information is less than or equal to a quantity threshold value (NVDTH, which stands for “NUM VALID DETECTION TO HOLD”) to generate a confirmation result. When the confirmation result is yes, the processor 300 executes step S264h; otherwise, when the confirmation result is no, the processor 300 executes step S264i.

In FIG. 5C, step S264h is used to reduce the score value in large increments, which includes steps S4ha, S4hb, S4hc, S4hd, S4he, S4hf, S4hg, S4hh, S4hi, S4hj, S4hk, S4hl. Step S4ha includes confirming whether the score value is greater than 0 to generate a first confirmation result. When the first confirmation result is yes, the processor 300 executes step S4hb; otherwise, the processor 300 executes step S4hc. Step S4hb includes performing a subtraction computation on the score value (subtracting 3). Step S4hc includes confirming whether the number of point cloud information is equal to 0 and confirming whether the score value is less than a preset score value (SCORE_MAX_VALUE/1.5) to generate a second confirmation result. When the second confirmation result is yes, the processor 300 executes step S4hd; otherwise, the processor 300 executes step S4hi. Step S4hd includes performing a subtraction computation on the score value (subtracting 2). Step S4he includes confirming whether the average value of the signal-to-noise ratios is greater than a preset average value (v4) to generate a third confirmation result. When the third confirmation result is yes, the processor 300 executes step S4hf; otherwise, the processor 300 executes step S4hg. Step S4hf includes performing a subtraction computation on the score value (subtracting 2). Step S4hg includes confirming whether the average value of the signal-to-noise ratios is greater than the preset average value (v1) to generate a fourth confirmation result. When the fourth confirmation result is yes, the processor 300 executes step S4hh; otherwise, the processor 300 executes step S4hi. Step S4hh includes performing a subtraction computation on the score value (subtracting 1). Step S4hi includes confirming whether the cycle count parameter is greater than or equal to the hold alarm time threshold value to generate a fifth confirmation result. When the fifth confirmation result is yes, the processor 300 executes step S4hj; otherwise, the processor 300 executes step S4hk. Step S4hj includes setting the state parameter to a second state parameter, and setting the cycle count parameter, the hold alarm time threshold value, and the score value all to 0. Step S4hk includes confirming whether the score value is less than or equal to a preset score value (SCORE_MAX_HIGH_CONFIDENT) to generate a sixth confirmation result. When the sixth confirmation result is yes, the processor 300 executes step S4hl; otherwise, the step S264h ends. Step S4hl includes performing an addition computation on the cycle count parameter (adding 1).

In FIG. 5D, step S264i is used to reduce the score value in small increments, which includes steps S4ia, S4ib, S4ic, S4id, S4ie, S4if, S4ig, S4ih, S4ii, S4ij. Step S4ia includes confirming whether the score value is greater than 0 to generate a first confirmation result. When the first confirmation result is yes, the processor 300 executes step S4ib; otherwise, the processor 300 executes step S4ig. Step S4ib includes performing a subtraction computation on the score value (subtracting 2). Steps S4ic, S4id, S4ie, S4if are the same as steps S4he, S4hf, S4hg, S4hh in FIG. 5C; steps S4ig, S4ih are the same as steps S4hk, S4hl in FIG. 5C; steps S4ii, S4ij are the same as steps S4hi, S4hj in FIG. 5C, and will not be repeated herein.

In the embodiments from FIG. 3 to FIG. 5D, the quantity threshold values (NVDT_1, NVDT_2, NVDT_3) are equal to 3, 2, 3, respectively, the average threshold values (AST_1, AST_2) are equal to 1.5, 2.0, respectively, the preset stable value (STABLE_LEVEL) is equal to 2, the preset alarm activation threshold value (SCORE_THRESHOLD_ACTIVE) is equal to 16, the preset alarm period (HOLD_TIME_CYCLE) is equal to 15, the preset acceleration reduction threshold value (SCORE_THRESHOLD_PROTECT_DECREASE_QUICK) is equal to 6, the second preset average threshold value (ASRDIO) is equal to 2, the second preset quantity threshold value (NVDRDIO) is equal to 2, the quantity threshold value (NVDTH) is equal to 2, the maximum score value (SCORE_MAX_VALUE) is equal to 46, the preset average value (v4) is equal to 27 watts, the preset score value (SCORE_MAX_HIGH_CONFIDENT) is equal to 15. The present disclosure is not limited thereto.

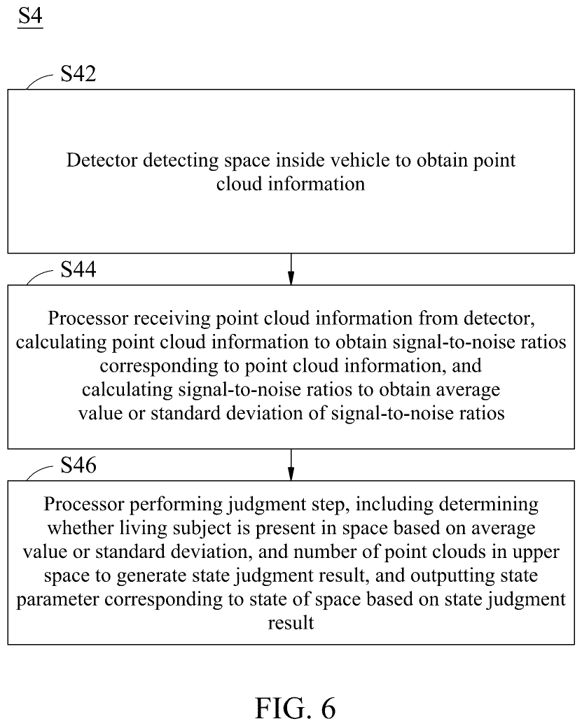

FIG. 6 is a flowchart of the in-vehicle living subject monitoring method S4 according to a fourth embodiment of the present disclosure. Referring to FIGS. 1 and 6, the in-vehicle living subject monitoring method S4 is used to monitor the space 110 inside the vehicle and is applied to the in-vehicle living subject monitoring system 100, which includes steps S42, S44, S46. Step S42 includes detecting the space 110 by the detector 200 to obtain multiple point cloud information. Step S44 includes receiving the point cloud information from the detector 200 by the processor 300, and calculating the point cloud information to obtain multiple signal-to-noise ratios corresponding to the point cloud information, and calculating the signal-to-noise ratios to obtain either the average value or the standard deviation of the signal-to-noise ratios. Step S46 includes performing a judgment step by the processor 300, where the judgment step includes determining whether a living subject 102 is present in the space 110 based on either the average value or the standard deviation and the number of the point clouds in the upper space 112 to generate a state judgment result, and outputting the state parameter corresponding to the state of the space 110 based on the state judgment result. Thus, the in-vehicle living subject monitoring method S4 of the present disclosure immediately determines whether a child is alone in the space 110 and provides a warning by calculating either the average value or the standard deviation and the number of the point clouds in the upper space 112 of the vehicle, and using the score value calculation to obtain the state parameter corresponding to the space 110 inside the vehicle.

From the above embodiments, the present disclosure has the following advantages. First, by determining the average value and standard deviation and calculating the score value to obtain the state parameter corresponding to the in-vehicle space, it can effectively determine whether a child is alone in the in-vehicle space and whether to issue a warning, solving the problem of poor practical application effects of conventional technology. Second, through a comprehensive determination based on either the average value or the standard deviation combined with the number of the point clouds in the upper space of the vehicle, and by calculating the score value to obtain the state parameter corresponding to the in-vehicle space, it can immediately determine whether a child is alone in the in-vehicle space and whether to issue a warning.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An in-vehicle living subject monitoring method for monitoring a space inside a vehicle, the in-vehicle living subject monitoring method comprising:
detecting, with a detector, the space inside the vehicle to obtain a plurality of point cloud information;
receiving, with a processor, the plurality of point cloud information from the detector, calculating the plurality of point cloud information to obtain a plurality of signal-to-noise ratios corresponding to the plurality of point cloud information, and calculating the plurality of signal-to-noise ratios to obtain an average value and a standard deviation of the plurality of signal-to-noise ratios; and
performing, with the processor, a judging step comprising judging whether a living subject is present in the space inside the vehicle according to the average value and the standard deviation to generate a state judgment result, and outputting a state parameter corresponding to a state of the space inside the vehicle according to the state judgment result.

2. The in-vehicle living subject monitoring method according to claim 1, wherein the judging step further comprises:
comparing whether the average value of the plurality of signal-to-noise ratios is less than or equal to a preset average value to generate a first comparison result;
comparing whether the standard deviation of the plurality of signal-to-noise ratios is between two preset standard deviations to generate a second comparison result; and
judging whether the living subject is present in the space inside the vehicle according to the first comparison result and the second comparison result;
wherein the preset average value and the two preset standard deviations correspond to a plurality of characteristic values of the living subject detected by the detector.

3. The in-vehicle living subject monitoring method according to claim 2, wherein,
when the first comparison result is yes, and the second comparison result is yes, the processor judges that the living subject is present in the space inside the vehicle.

4. The in-vehicle living subject monitoring method according to claim 2, wherein the judging step further comprises:
judging whether a number of point clouds in an upper space of the space inside the vehicle is less than or equal to a preset upper space point number value to generate a point number determination result; and
judging whether the living subject is present in the space inside the vehicle according to the first comparison result, the second comparison result, and the point number determination result.

5. The in-vehicle living subject monitoring method according to claim 4, wherein,
when the first comparison result is yes, the second comparison result is yes, and the point number determination result is yes, the processor judges that the living subject is present in the space inside the vehicle.

6. The in-vehicle living subject monitoring method according to claim 1, wherein the judging step further comprises:
determining whether to execute a first score adjustment procedure or a second score adjustment procedure in a current cycle based on the state parameter of a previous cycle to generate a decision result; and
performing a computation on a score value based on the decision result, and determining whether to adjust the state parameter based on the score value computed by the computation;
wherein the state parameter is one of a first state parameter and a second state parameter, the first state parameter represents that the living subject is present in the space inside the vehicle, the second state parameter represents that the living subject is not present in the space inside the vehicle, the first score adjustment procedure and the second score adjustment procedure are different from each other, the first score adjustment procedure corresponds to the state parameter of the previous cycle being the first state parameter, and the second score adjustment procedure corresponds to the state parameter of the previous cycle being the second state parameter.

7. The in-vehicle living subject monitoring method according to claim 6, wherein the first score adjustment procedure comprises:
judging whether the plurality of point cloud information is a valid detection based on a first detection judgment condition to generate a first detection judgment result, wherein the valid detection comprises a presence of the living subject in the space inside the vehicle, the first detection judgment condition comprises:
a number of the plurality of point cloud information being greater than or equal to a first preset quantity threshold value; and
the average value of the plurality of the signal-to-noise ratios being greater than a first preset average threshold value.

8. The in-vehicle living subject monitoring method according to claim 7, wherein,
when the first detection judgment result is yes, the processor performs at least one addition computation on the score value based on a first parameter set to generate a first adjusted score value, and then determines whether to adjust the state parameter based on the first adjusted score value; and
when the first detection judgment result is no, the processor performs at least one subtraction computation on the score value based on another first parameter set to generate another first adjusted score value, and then determines whether to adjust the state parameter based on the another first adjusted score value;
wherein the first parameter set comprises a child sensing state parameter, a consistency of a movement of the living subject, the score value, and the number of the plurality of point cloud information, a size of the score value corresponds to a likelihood that the living subject is a child, and the another first parameter set comprises the child sensing state parameter, the score value, and the number of the plurality of point cloud information.

9. The in-vehicle living subject monitoring method according to claim 6, wherein the second score adjustment procedure comprises:
judging whether the plurality of point cloud information is a valid detection based on a second detection judgment condition to generate a second detection judgment result, wherein the valid detection comprises a presence of the living subject in the space inside the vehicle, the second detection judgment condition comprises:
the average value of the plurality of signal-to-noise ratios being greater than a second preset average threshold value;
a number of the plurality of point cloud information being greater than or equal to a second preset quantity threshold value; and
a child sensing state parameter being equal to 1, wherein the child sensing state parameter equal to 1 represents that the living subject is present in the space inside the vehicle and the living subject is a child.

10. The in-vehicle living subject monitoring method according to claim 9, wherein,
when the second detection judgment result is yes, the processor performs at least one addition computation on the score value based on a second parameter set to generate a second adjusted score value, and then determines whether to adjust the state parameter based on the second adjusted score value; and
when the second detection judgment result is no, the processor performs at least one subtraction computation on the score value based on another second parameter set to generate another second adjusted score value, and then determines whether to adjust the state parameter based on the another second adjusted score value;
wherein the second parameter set comprises the score value and a consistency of a movement of the living subject, a size of the score value corresponds to a likelihood that the living subject is the child, and the another second parameter set comprises the number of the plurality of point cloud information, the score value, the average value of the plurality of signal-to-noise ratios, and a cycle count parameter.

11. The in-vehicle living subject monitoring method according to claim 6, further comprising:
determining, with the processor, whether to issue a warning signal based on the state parameter of the space inside the vehicle in the current cycle;
wherein when the state parameter of the space inside the vehicle in the current cycle is the first state parameter, the processor issues the warning signal;
wherein when the state parameter of the space inside the vehicle in the current cycle is the second state parameter, the processor does not issue the warning signal.

12. An in-vehicle living subject monitoring method for monitoring a space inside a vehicle, the in-vehicle living subject monitoring method comprising:
detecting, with a detector, the space inside the vehicle to obtain a plurality of point cloud information;
receiving, with a processor, the plurality of point cloud information from the detector, calculating the plurality of point cloud information to obtain a plurality of signal-to-noise ratios corresponding to the plurality of point cloud information, and calculating the plurality of signal-to-noise ratios to obtain an average value or a standard deviation of the plurality of signal-to-noise ratios; and
performing, with the processor, a judging step comprising judging whether a living subject is present in the space inside the vehicle according to the average value or the standard deviation of the plurality of signal-to-noise ratios and a number of point clouds in an upper space of the space inside the vehicle to generate a state judgment result, and outputting a state parameter corresponding to a state of the space inside the vehicle according to the state judgment result.

13. The in-vehicle living subject monitoring method according to claim 12, wherein when the processor obtains the average value of the plurality of signal-to-noise ratios, the judging step further comprises:
comparing whether the average value of the plurality of signal-to-noise ratios is less than or equal to a preset average value to generate a first comparison result;
judging whether the number of the point clouds in the upper space of the space inside the vehicle is less than or equal to a preset upper space point number value to generate a point number determination result; and
judging whether the living subject is present in the space inside the vehicle according to the first comparison result and the point number determination result;
wherein the preset average value corresponds to a characteristic value of the living subject detected by the detector;
wherein when the first comparison result is yes and the point number determination result is yes, the processor judges that the living subject is present in the space inside the vehicle.

14. The in-vehicle living subject monitoring method according to claim 12, wherein when the processor obtains the standard deviation of the plurality of signal-to-noise ratios, the judging step further comprises:
comparing whether the standard deviation of the plurality of signal-to-noise ratios is between two preset standard deviations to generate a second comparison result;
judging whether the number of the point clouds in the upper space of the space inside the vehicle is less than or equal to a preset upper space point number value to generate a point number determination result; and
judging whether the living subject is present in the space inside the vehicle according to the second comparison result and the point number determination result;
wherein the two preset standard deviations correspond to two characteristic values of the living subject detected by the detector;
wherein when the second comparison result is yes and the point number determination result is yes, the processor judges that the living subject is present in the space inside the vehicle.

15. The in-vehicle living subject monitoring method according to claim 12, further comprising:
determining, with the processor, whether to issue a warning signal based on the state parameter of the space inside the vehicle, wherein the state parameter is one of a first state parameter and a second state parameter, the first state parameter represents that the living subject is present in the space inside the vehicle, the second state parameter represents that the living subject is not present in the space inside the vehicle;
wherein when the state parameter of the space inside the vehicle is the first state parameter, the processor issues the warning signal;
wherein when the state parameter of the space inside the vehicle is the second state parameter, the processor does not issue the warning signal.

16. An in-vehicle living subject monitoring system for monitoring a space inside a vehicle, the in-vehicle living subject monitoring system comprising:
a detector for detecting the space inside the vehicle to obtain a plurality of point cloud information; and
a processor connected to the detector, and receiving the plurality of point cloud information, the processor calculating the plurality of point cloud information to obtain a plurality of signal-to-noise ratios corresponding to the plurality of point cloud information, calculating the plurality of signal-to-noise ratios to obtain an average value and a standard deviation of the plurality of signal-to-noise ratios, and performing a judging operation;
wherein the judging operation comprises judging whether a living subject is present in the space inside the vehicle according to the average value and the standard deviation to generate a state judgment result, and outputting a state parameter corresponding to a state of the space inside the vehicle according to the state judgment result.

17. The in-vehicle living subject monitoring system according to claim 16, wherein the judging operation further comprises:
comparing whether the average value of the plurality of signal-to-noise ratios is less than or equal to a preset average value to generate a first comparison result;
comparing whether the standard deviation of the plurality of signal-to-noise ratios is between two preset standard deviations to generate a second comparison result; and
judging whether the living subject is present in the space inside the vehicle according to the first comparison result and the second comparison result;
wherein the preset average value and the two preset standard deviations correspond to a plurality of characteristic values of the living subject detected by the detector;
wherein when the first comparison result is yes and the second comparison result is yes, the processor judges that the living subject is present in the space inside the vehicle.

18. The in-vehicle living subject monitoring system according to claim 17, wherein the judging operation further comprises:
judging whether a number of point clouds in an upper space of the space inside the vehicle is less than or equal to a preset upper space point number value to generate a point number determination result; and
judging whether the living subject is present in the space inside the vehicle according to the first comparison result, the second comparison result, and the point number determination result;
wherein when the first comparison result is yes, the second comparison result is yes, and the point number determination result is yes, the processor judges that the living subject is present in the space inside the vehicle.

19. The in-vehicle living subject monitoring system according to claim 16, wherein the judging operation further comprises:
determining whether to execute a first score adjustment procedure or a second score adjustment procedure in a current cycle based on the state parameter of a previous cycle to generate a decision result; and
performing a computation on a score value based on the decision result, and determining whether to adjust the state parameter based on the score value computed by the computation;
wherein the state parameter is one of a first state parameter and a second state parameter, the first state parameter represents that the living subject is present in the space inside the vehicle, the second state parameter represents that the living subject is not present in the space inside the vehicle, the first score adjustment procedure and the second score adjustment procedure are different from each other, the first score adjustment procedure corresponds to the state parameter of the previous cycle being the first state parameter, and the second score adjustment procedure corresponds to the state parameter of the previous cycle being the second state parameter.

20. The in-vehicle living subject monitoring system according to claim 19, wherein the processor determines whether to issue a warning signal based on the state parameter of the space inside the vehicle in the current cycle;
wherein when the state parameter of the space inside the vehicle in the current cycle is the first state parameter, the processor issues the warning signal;
wherein when the state parameter of the space inside the vehicle in the current cycle is the second state parameter, the processor does not issue the warning signal.
